(19) United States
(12) Patent Application Publication
(10) Pub. No.: US 2022/0403568 A1
(43) Pub. Date: Dec. 22, 2022

(54) KNITTED SOCKS

(71) Applicant: THE LYCRA COMPANY LLC, Wilmington, DE (US)

(72) Inventors: Juan CERA, Middletown, DE (US); Geoffrey D. HIETPAS, Newark, DE (US)

(21) Appl. No.: 17/770,703

(22) PCT Filed: Nov. 3, 2020
(86) PCT No.: PCT/US2020/058644

§ 371 Date: Apr. 21, 2022

Related U.S. Application Data
(60) Provisional application No. 62/930,234, filed on Nov. 4, 2019.

(51) Int. Cl. D04B 21/08; A41B 11/00

(52) U.S. Cl. CPC D04B 21/08; A41B 11/00; A41B 2500/10

(57) ABSTRACT

Knitted socks or other garments or portions thereof and methods for producing knitted socks or other garments or portions thereof which stay in place when worn with less or no spandex or rubber fiber in the sock or other garment or portion thereof are provided.

### FIELD

This disclosure relates to knitted socks or other garments or portions thereof and methods for producing these knitted socks or other garments or portions thereof which stay in place when worn with less or no spandex or rubber fiber in the sock or other garments or portions thereof.

### BACKGROUND

Socks are typically made by a knitting process using yarns.

Yarns used in this knitting process are typically made from fibers comprised of cotton, polyester, acrylic and/or nylon.

Further, in order for the sock to stay up on the leg during wear the upper part of the sock, commonly known as the ‘sock-top’, often includes a spandex or rubber fiber. This spandex or rubber fiber is usually incorporated as a covered yarn. It may be single or double covered. The covering is often nylon or polyester.

During knitting, this yarn is laid-in such that the yarn is oriented horizontal to the length direction of the sock. This laying in may be accomplished in a 1×1 (one needle up, one needle down), 2×1, 3×1, etc.

However the inclusion of spandex or rubber fiber presents certain undesirable limitations for the user. For example, spandex and rubber fibers are more sensitive to chlorine attack and their presence may limit the use of bleach in consumer care. In addition, inclusion . of spandex and rubber fibers in this application can sometimes be too powerful and lead to red marking on the skin after prolonged wear. Further, the inclusion of spandex or rubber increases the complexity of fiber separation in the event that the garment is recycled.

A knitted sock construction meeting consumer expectations of staying in place but without the aforementioned limitations of inclusion of spandex or rubber fiber is needed.

### SUMMARY

An aspect of the present invention relates to a knitted sock or other garment or portion thereof which stays in place upon wear without inclusion of spandex or rubber fiber. In one nonlimiting embodiment, the knitted sock or other garment or portion thereof comprises a mechanical stretch elastic yarn in place of spandex or rubber fiber.

Another aspect of the present invention relates to a method for producing knitted socks or other garments or portions thereof which stay in place upon wear without inclusion of spandex or rubber fiber in the sock or other garment or portion thereof. In one nonlimiting embodiment, the method comprises knitting a mechanical stretch elastic yarn into the sock or other garment or portion thereof in place of spandex or rubber fiber.

Another aspect of the present invention relates to a knitted sock or other garment or portion thereof which includes less spandex or rubber fiber as compared to a knitted sock or other garment or portion thereof with 2-3% spandex but which stays in place upon wear similarly to a knitted sock or other garment or portion thereof comprising 2-3% spandex. In one nonlimiting embodiment, the knitted sock or other garment or portion thereof comprises a mechanical stretch elastic yarn in place of a portion of spandex or rubber fiber.

Another aspect of the present invention relates to a method for producing knitted socks or other garments or portions thereof which stay in place upon wear which include less spandex or rubber fiber in the knitted sock or other garment or portion thereof as compared to a knitted sock or other garment or portion thereof which contains between 2-3% spandex. In one nonlimiting embodiment, the method comprises knitting a mechanical stretch elastic yarn into the sock or other garment or portion thereof in place of a portion of spandex or rubber fiber.

### DETAILED DESCRIPTION

Provided by this disclosure are knitted socks which stay in place when worn and methods for producing these knitted socks with decreased amounts or without the inclusion of spandex or rubber fiber in the sock. Other garments or portions thereof that have a laid-in yarn similar to a sock top construction within the scope of the invention include, but are not limited to, pantyhose waistbands and narrows which are used as the elastic waistband on undergarments.

Knitted socks and other garments or portions thereof of this disclosure comprise a mechanical stretch elastic yarn in place of all or a portion of spandex or rubber fiber. In one nonlimiting embodiment, the mechanical stretch elastic yarn is used in place of all or a portion of spandex or rubber fiber in at least a top portion of the knitted sock, also routinely referred to by those skilled in the art as the sock top.

By “mechanical stretch elastic yarn” as used herein, it is meant to include polyester bicomponent fibers such as, but in no way limited to, elasterell-p or T400® from The LYCRA Company, as well as other mechanical stretch bicomponent yarns such as, but in no way limited to, side-by-side and eccentric sheath core combinations of polyethylene terephthalate, polypropylene terephthalate and/or polybutylene terephthalate. In some nonlimiting embodiments, the mechanical stretch elastic yarn is combined with another yarn such as, but not limited to, yarn made from polyester, nylon, acrylic, or cotton by twisting or intermingling.

In some nonlimiting embodiments, the filament count of the bicomponent fiber is in a range such that the denier per filament ranges from 0.5 to 8.0.

In one nonlimiting embodiment, the mechanical stretch elastic yarn replaces all spandex or rubber fiber in the knitted sock or other garment or portion thereof. In one nonlimiting embodiment, the mechanical stretch elastic yarn replaces all spandex or rubber fiber in a top portion of a knitted sock.

In another nonlimiting embodiment, the knitted sock or other garment or portion thereof further comprises a small amount of spandex or rubber fiber for additional holding force and shape retention . For example, knitted socks commonly have 1-3%, or more often 2-3% spandex content. In some nonlimiting embodiments of the present invention, this may be reduced to about 0.5-1.5%. In one nonlimiting embodiment, this is achieved by using alternating courses of a bare or covered mechanical stretch elastic yarn and a bare or covered spandex yarn. In one nonlimiting embodiment, the small amount of spandex or rubber fiber is in the sock top and/or sock body. In these nonlimiting embodiments, it is expected that use of the combination of spandex or rubber with the mechanical stretch elastic yarn will lower the amount of required spandex or rubber fiber in the sock or other garment or portion thereof, thereby improving the economics of production well as provide an overall improved combination of fit and comfort during wear.

In some nonlimiting embodiments, a polyester yarn is included in addition to the mechanical stretch elastic yarn.

Examples of additional fibers included in the socks of this disclosure include, but are not limited to, cotton, acrylic and/or nylon.

This disclosure also relates to methods for producing socks or other garments or portions thereof which stay in place upon wear without inclusion or with inclusion of less spandex or rubber fiber in the sock or other garment or portion thereof.

In one nonlimiting embodiment, the method comprises knitting a mechanical stretch elastic yarn into the sock or other garment or portion thereof in place of spandex or rubber fiber. In one nonlimiting embodiment, the method comprises knitting the mechanical stretch elastic yarn into a top portion of a sock in place of spandex or rubber fiber.

In one nonlimiting embodiment, the method comprises knitting a mechanical stretch elastic yarn and a decreased amount of spandex or rubber fiber into the sock or other garment or portion thereof. For example, in this nonlimiting embodiment, a sock could be made with only 0.5-1.5% of spandex vs. the 1-3% or 2-3% conventionally used. In one nonlimiting embodiment, the method comprises knitting a mechanical stretch elastic yarn and a decreased amount of spandex or rubber fiber into a top portion of the sock using a laid-in structure. The body of this sock could then be made with or without the use of spandex.

In some nonlimiting embodiments, in addition to incorporating the mechanical stretch elastic yarn into the knitted sock or other garment or portion thereof, the method further comprises a selected wet process to finish the socks or other garments or portions thereof after they are knitted.

In one nonlimiting embodiment, the selected wet process comprises initial placement in water that is at 90 to 100° C. for 10 seconds to 5 minutes, and then drying the fabric by letting it sit in ambient temperatures, or by using a heated drying process. The sock or other garment or portion thereof may also be dried and set by using a boarding machine following conventional processes.

In another nonlimiting embodiment, the selected wet process comprises exposing the knitted sock or other garment or portion thereof to steam in any region from 0.01 to 6 bar for a period sufficient to fully develop the crimp in the mechanical stretch elastic yarns. In one nonlimiting embodiment, the steam exposure is applied for 10 to 180 seconds. Optionally, the knitted socks of other garments or portions thereof produced in accordance with the methods of this disclosure are boarded using a conventional boarding machine.

As will be understood by the skilled artisan upon reading this disclosure, other types of garments, i.e. in addition to socks, hosiery and undergarment, could be enhanced with this technology to create new consumer value.

The following example demonstrates the present disclosure and its capability for use in producing socks which stay in place without inclusion or with decreased amounts of spandex or rubber fiber. The invention is capable of other and different embodiments, and its several details are capable of modification in various apparent respects, without departing from the scope and spirit of the present invention. Accordingly, the examples are to be regarded as illustrative and not as restrictive.

### EXAMPLES

### Example 1

A sock of the invention was knitted using a 14 gauge Lonati 615D knitting machine that possessed 144 needles with a 3.75 inch cylinder. A 300 denier-68 filament polyester bicomponent yarn (T400® fiber available from The LYCRA Company) and a 150 denier-68 filament T400® fiber were both used in the sock top area. The 300 denier yarn was laid-in in a 3×1 construction, and the 150 denier t400® was knitted-in along with a two-ply 30/1 English cotton count ring spun yarn made from 100% polyester staple fiber (written as 2/30). The foot (also known as body and heel section) of the sock were knitted with the 300d T400® fiber and a two-ply 20/1 English cotton count (2/20) ring spun yarn made from 100% polyester staple fiber. After knitting the sock was placed unrestrained in water held at 95° C. for 5 minutes. It was then allowed to air dry. The sock produced in this way had excellent bulk, handfeel, and stay-up performance during wear as evidenced by an on-body wear trial. By total weight of the sock, the fiber content was 66% T400® and 34% polyester.

### Example 2

A sock was knitted similarly to Example 1, however the 150 denier T400® fiber was replaced by 300 denier T400® fiber. After being placed unrestrained in water held at 95° C. for 5 minutes, the sock was then boarded at 1 bar steam pressure. The sock produced in this way had excellent bulk, handfeel, and stay-up performance during wear as evidenced by an on-body wear trial. By total weight of the sock, the fiber content was 66% T400® and 34% polyester.

### Comparative Example

A control sock was knitted similarly to Example 1, however 140 denier spandex (LYCRA® fiber type 162B available from The LYCRA Company) that was double covered with nylon as the laid-in yarn was used in the sock top in a 3×1 construction. Additionally, a 150 denier-96 filament textured polyester fiber was co-knit with a two-ply 30 cotton count 100% polyester staple fiber yarn (2/30). After knitting, the sock was placed unrestrained in water held at 95° C. for 5 minutes. The sock was then boarded at 1 bar steam pressure. The sock produced in this way had excellent bulk, handfeel, and stay-up performance during wear as evidenced by an on-body wear trial. By total weight of the sock, the fiber content was 2% spandex, 4% nylon and 94% polyester.

### Evaluation of Holding Force

The socks from Examples 1 and 2 and the Comparative Example were evaluated using a compression testing apparatus [Salzmann Medico MST MK-III]. The pressure was measured (in mmHG) for each sock when placed on a size-8 wooden legform. Three measurements were taken, one just above the heel, one at the center point on the sock top and one near the top of the sock top. As shown in Table 1, the holding force (compression as measured in mmHg) of the Comparative Example with spandex was unexpectedly lower than Examples 1 and 2 made without use of spandex.

TABLE 1

| Example | Bottom | Middle | Top |
|---|---|---|---|
| Example 1 | 13 | 13 | 11 |
| Example 2 | 17 | 15 | 15 |
| Comparative Example | 11 | 10 | 10 |

1. A knitted sock or other garment or portion thereof comprising a mechanical stretch elastic yarn, wherein said knitted sock or other garment or portion thereof excludes spandex or rubber fiber.

2. The knitted sock or other garment or portion thereof of claim 1 wherein the mechanical stretch elastic yarn comprises bicomponent polyester fiber.

3. The knitted sock or other garment or portion thereof of claim 1 further comprising polyester yarn.

4. The knitted sock of claim 1 wherein the mechanical stretch elastic yarn is in a top portion of said knitted sock.

5. A knitted sock or other garment or portion thereof comprising a mechanical stretch elastic yarn and less than 2% spandex or rubber fiber.

6. The knitted sock or other garment or portion thereof of claim 5 comprising 0.5 to 1.5% spandex or rubber fiber.

7. The knitted sock or other garment or portion thereof of claim 5 wherein the mechanical stretch elastic yarn comprises bicomponent polyester fiber.

8. The knitted sock or other garment or portion thereof of claim 5 further comprising polyester yarn.

9. The knitted sock of claim 5 wherein the mechanical stretch elastic yarn is in a top portion of said knitted sock.

10. A method for producing the knitted sock or other garment or portion thereof of claim 1, said method comprising knitting the mechanical stretch elastic yarn into the sock or other garment or portion thereof in place of spandex or rubber fiber.

11. A method for producing the knitted sock of claim 5, said method comprising knitting the mechanical stretch elastic yarn into the sock or other garment or portion thereof in place of a portion of spandex or rubber fiber.

12. The method of claim 10 further comprising placing the knitted sock or other garment or portion thereof in water that is at 90 to 100° C. for 10 seconds to 5 minutes.

13. The method of claim 10 further comprising exposing the knitted sock or other garment or portion thereof to steam in any region from 0.01 to 6 bar for a period sufficient to fully develop the crimp in the mechanical stretch elastic yarns.

14. The method of claim 10 further comprising boarding the knitted sock or other garment or portion thereof.

15. The method of claim 11 further comprising placing the knitted sock or other garment or portion thereof in water that is at 90 to 100° C. for 10 seconds to 5 minutes.

16. The method of claim 11 further comprising exposing the knitted sock or other garment or portion thereof to steam in any region from 0.01 to 6 bar for a period sufficient to fully develop the crimp in the mechanical stretch elastic yarns.

17. The method of claim 11 further comprising boarding the knitted sock or other garment or portion thereof.
